(19) United States
(12) Patent Application Publication
(10) Pub. No.: US 2006/0272899 A1
(43) Pub. Date: Dec. 7, 2006

(54) Ladder

(76) Inventor: Wei-Hao Chang, Yuan-Lin Chen (TW)

Correspondence Address: LOWE HAUPTMAN BERNER, LLP, 1700 DIAGONAL ROAD, SUITE 300, ALEXANDRIA, VA, 22314, US

(21) Appl. No.: 11/142,390

(22) Filed: Jun. 2, 2005

(51) Int. Cl. E06C 7/00

(52) U.S. Cl. 182/201

(57) ABSTRACT

A ladder includes: a ladder frame with a plurality of side rails and a plurality of ladder steps connected to the side rails; a plurality of legs mounted on the side rails, respectively, and adjustable for adjusting the overall length of each of the side rails and the respective one of the legs, each of the legs having a lower end; a plurality of shoes, each of which is pivoted to the lower end of a respective one of the legs, each of which has a bottom plate spaced apart from and disposed below the lower end of the respective one of the legs, and each of which is pivotable relative to the respective one of the legs; and a plurality of fasteners for retaining each of the shoes at a desired angular position relative to the respective one of the legs.

### BACKGROUND OF THE INVENTION

1. Field of the Invention

This invention relates to a ladder, more particularly to a ladder with angle adjustable shoes and extendable legs that are respectively received in sleeves secured to side rails of the ladder.

2. Description of the Related Art

Taiwanese patent publication number 256314 discloses a conventional ladder that includes a plurality of side rails, a plurality of steps connected to the side rails, a plurality of legs mounted telescopically on the side rails, and a plurality of shoes secured to bottom ends of the legs, respectively.

The conventional ladder is disadvantageous in that it becomes unstable when standing on an uneven ground surface due to an inappropriate contact angle between the shoes and the uneven ground surface.

### SUMMARY OF THE INVENTION

The object of the present invention is to provide a ladder with angle adjustable shoes that are capable of overcoming the aforesaid drawback of the conventional ladder.

Another object of this invention is to provide a ladder with sleeves secured to side rails of the ladder for receiving legs of the ladder so as to enhance the mechanical strength of the ladder.

According to one aspect of the present invention, there is provided a ladder that comprises: a ladder frame with a plurality of side rails and a plurality of ladder steps connected to the side rails; a plurality of legs mounted on the side rails, respectively, and adjustable for adjusting the overall length of each of the side rails and the respective one of the legs, each of the legs having a lower end; a plurality of shoes, each of which is pivoted to the lower end of a respective one of the legs, each of which has a bottom plate spaced apart from and disposed below the lower end of the respective one of the legs, and each of which is pivotable relative to the respective one of the legs; and a plurality of fasteners for retaining each of the shoes at a desired angular position relative to the respective one of the legs.

According to another aspect of the present invention, there is provided a ladder that comprises: a ladder frame with a plurality of side rails and a plurality of ladder steps connected to the side rails; a plurality of sleeves, each of which is secured to a respective one of the side rails, and each of which extends along the length of the respective one of the side rails; a plurality of legs, each of which extends respectively into the sleeves, and each of which is telescopically adjustable for adjusting the overall length of each of the side rails and the respective one of the legs; and a plurality of locking members for securing the legs to the sleeves.

### BRIEF DESCRIPTION OF THE DRAWINGS

In drawings which illustrate embodiments of the invention,

FIG. 1 is a perspective view of the first preferred embodiment of a ladder according to this invention;

FIG. 2 is a fragmentary perspective view of the first preferred embodiment;

FIG. 3 is a perspective view to illustrate how the first preferred embodiment is used in a situation where the ladder stands on a floor and a step above the floor;

FIG. 4 is a perspective view to illustrate how the first preferred embodiment is used in a situation where the ladder stands on an uneven ground surface;

FIG. 5 is a schematic side view of the second preferred embodiment of a ladder according to this invention in a state of use;

FIGS. 6 and 7 are fragmentary perspective views of the third preferred embodiment of a ladder according to this invention;

FIG. 8 is a fragmentary perspective view of the fourth preferred embodiment of a ladder according to this invention;

FIG. 9 is a fragmentary sectional view of the fourth preferred embodiment;

FIG. 10 is a schematic side view of the fifth preferred embodiment of a ladder according to this invention;

FIG. 11 is a fragmentary schematic view to illustrate how a leg of the fifth preferred embodiment is adjusted in length;

FIG. 12 is a schematic side view of the sixth preferred embodiment of a ladder according to this invention; and

FIG. 13 is a fragmentary schematic view to illustrate how a leg of the sixth preferred embodiment is adjusted in length.

### DETAILED DESCRIPTION OF THE PREFERRED EMBODIMENTS

Before the present invention is described in greater detail, it should be noted that same reference numerals have been used to denote like elements throughout the specification.

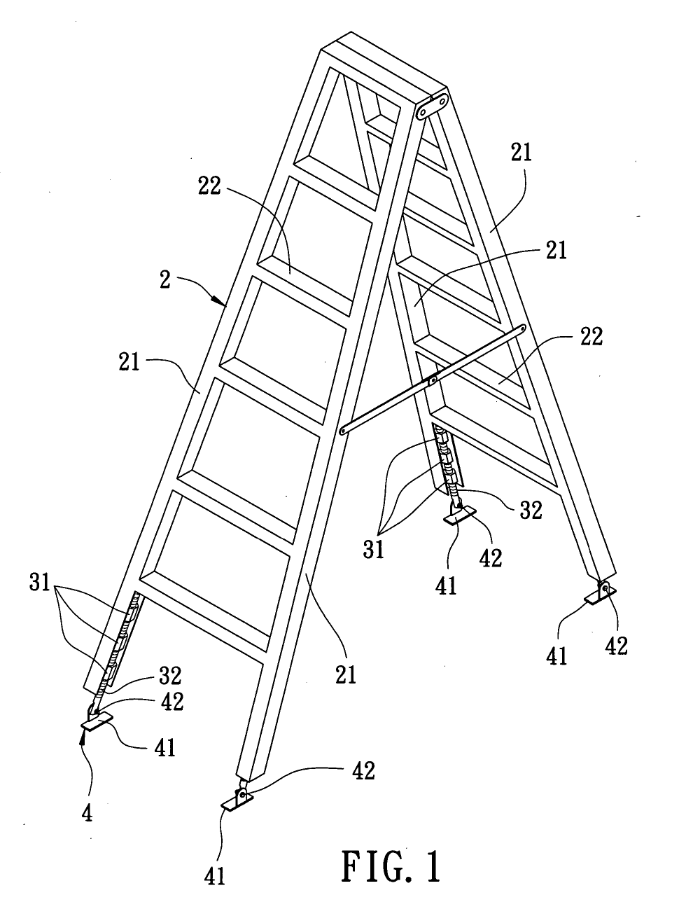

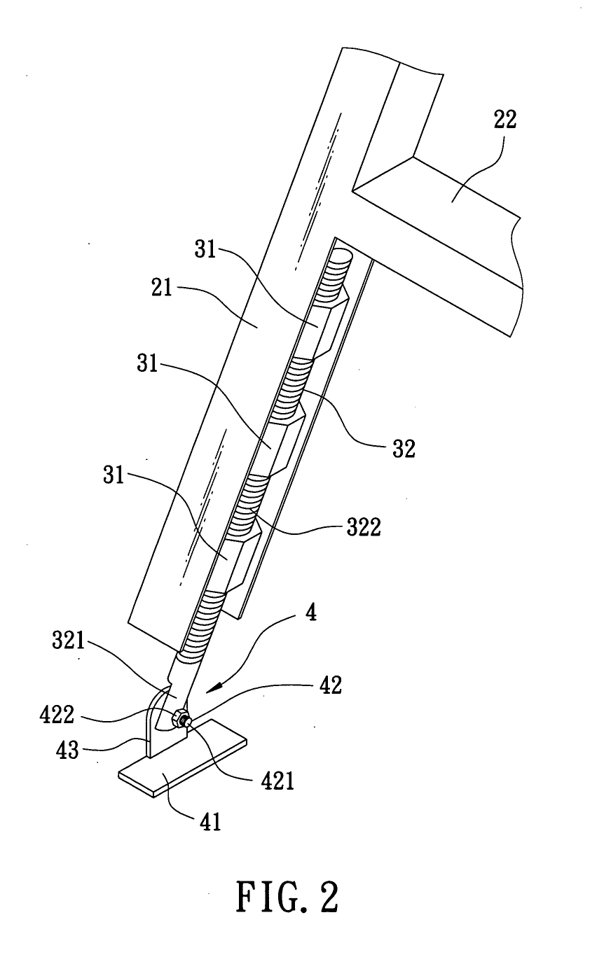

FIGS. 1 and 2 illustrate the first preferred embodiment of a step ladder according to this invention.

The step ladder includes: a ladder frame 2 with a plurality of side rails 21 and a plurality of ladder steps 22 connected to the side rails 21; a plurality of legs 32 mounted on the side rails 21, respectively, and telescopically adjustable for adjusting the overall length of each of the side rails 21 and the respective one of the legs 32, each of the legs 32 having a lower end 321; a plurality of shoes 4, each of which is pivoted to the lower end 321 of a respective one of the legs 32, each of which has a bottom plate 41 spaced apart from and disposed below the lower end 321 of the respective one of the legs 32, and each of which is pivotable relative to the respective one of the legs 32; and a plurality of fasteners 42 for retaining each of the shoes 4 at a desired angular position relative to the respective one of the legs 32.

In this embodiment, an adjusting mechanism includes a plurality of threaded members 31 that are secured to each of the side rails 21, and that are aligned along the length of the respective one of the side rails 21. Each of the legs 32 has a threaded segment 322 that is engageable with the threaded members 31 so as to permit adjustment of the overall length of each of the side rails 21 and the respective one of the legs 32.

Each of the shoes 4 further has a pivot plate 43 that extends from the bottom plate 41 in a transverse direction relative to the bottom plate 41. Each of the fasteners 42 includes a screw bolt 421 that extends through the lower end 321 of the respective one of the legs 32 and the pivot plate 43 of the respective one of the shoes 4, and a nut 422 that engages threadedly the screw bolt 421 so as to secure the fastener 42 to the respective leg 32.

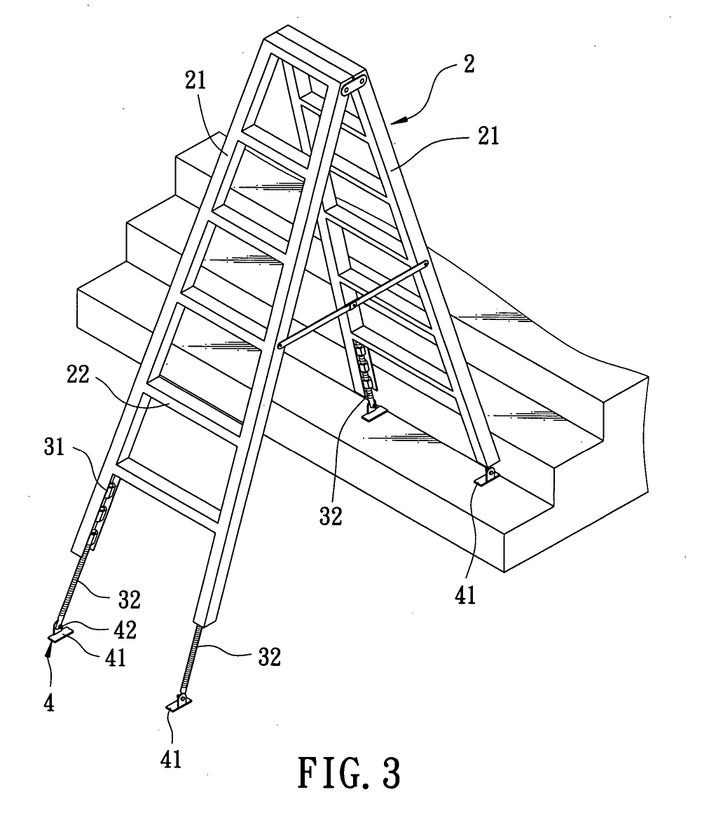

FIG. 3 illustrates how the first preferred embodiment is used in a situation where the step ladder stands on a floor and a step above the floor.

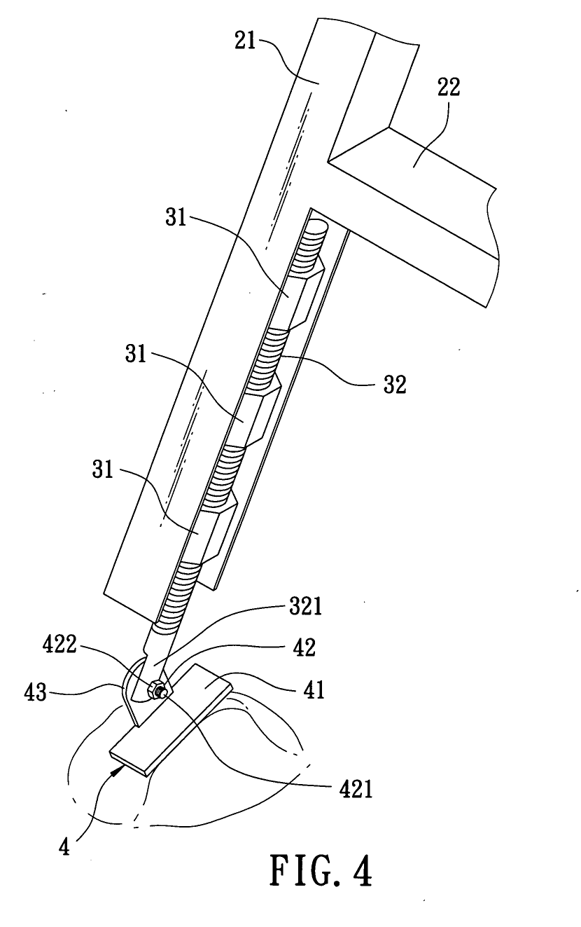

FIG. 4 illustrates how the first preferred embodiment is used in a situation where the ladder stands on an uneven ground surface. The shoe 4, which stands on the uneven ground surface, is adjusted in angular position relative to the respective leg 32 by loosening the respective fastener 42, followed by rotating the shoe 4 to the desired angular position, and then tightening the respective fastener 42, thereby enhancing the stability of the step ladder while standing on the uneven ground surface.

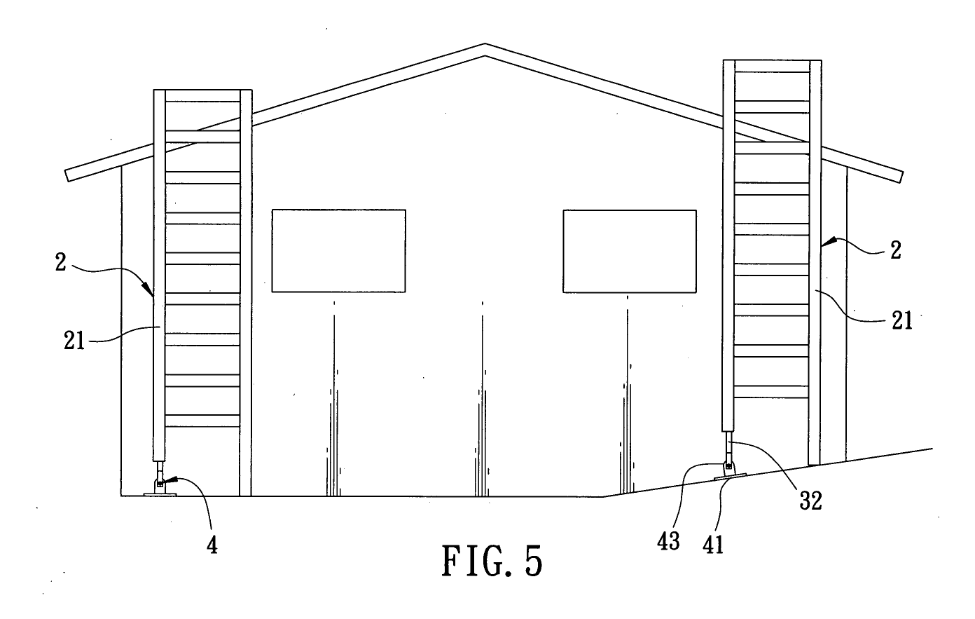

FIG. 5 illustrates the second preferred embodiment of a ladder according to this invention. The ladder of this embodiment differs from the previous embodiment in that instead of four side rails 21 in the previous embodiment, it is a straight-type ladder with two side rails 21 only.

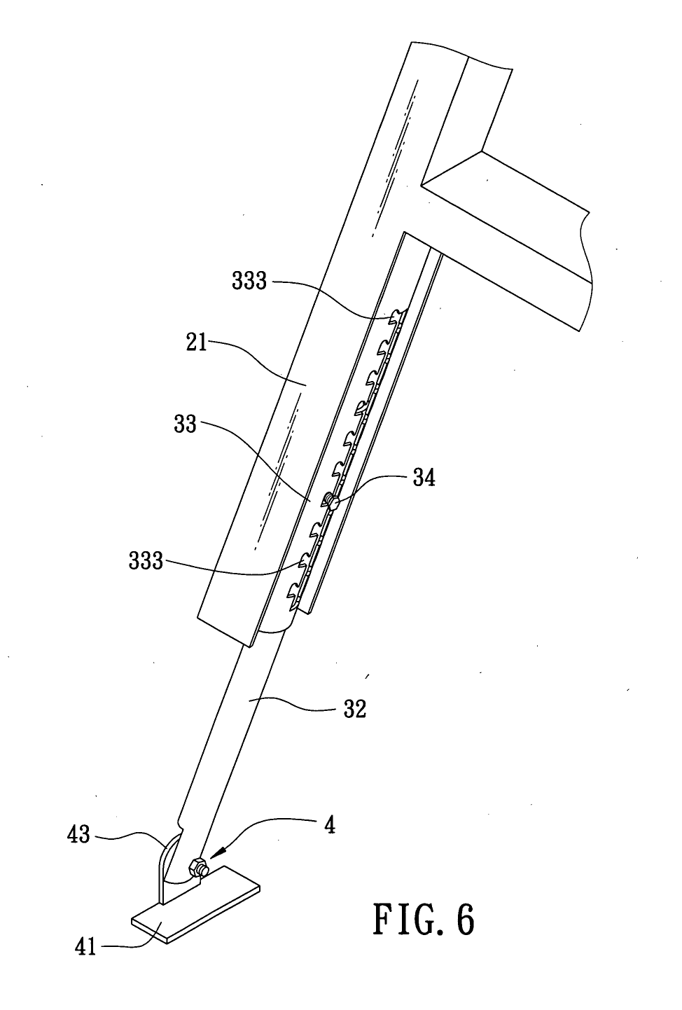

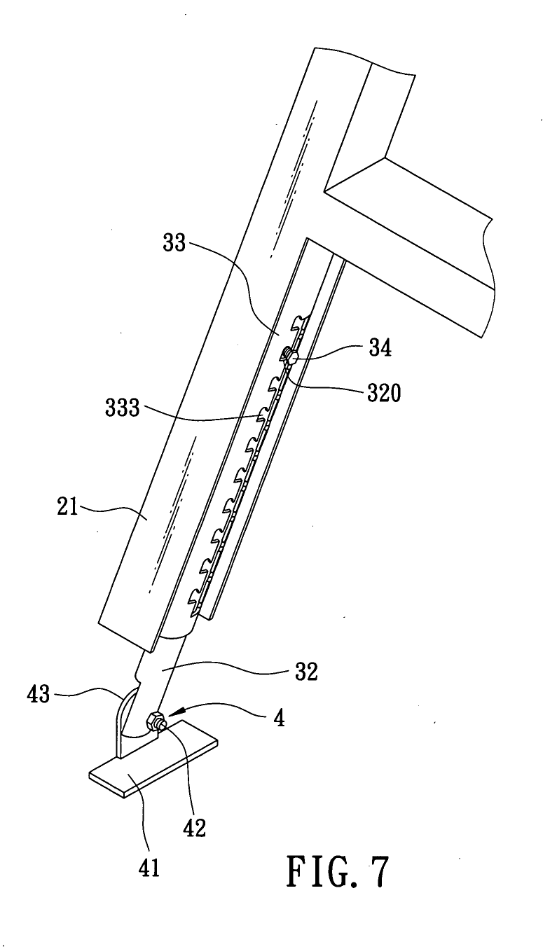

FIGS. 6 and 7 illustrate the third preferred embodiment of a ladder according to this invention. The ladder of this embodiment differs from the first embodiment in that the adjusting mechanism of this embodiment includes a plurality of sleeves 33, each of which is secured to a respective one of the side rails 21, each of which extends along the length of the respective one of the side rails 21, and each of which is formed with a plurality of spaced apart retaining grooves 333 that are aligned along the length of the sleeve 33. Each of the legs 32 extends into a respective one of the sleeves 33, is formed with a retaining hole 320, and is telescopically movable relative to the respective one of the sleeves 33 so as to permit alignment of the retaining hole 320 with a selected one of the retaining grooves 333. A plurality of locking members 34 (only one locking member 34 is shown in FIGS. 6 and 7), each of which is in the form of a bolt, are used for positioning the legs 32 at a desired position relative to the side rails 21. Each of the locking members 34 extends through the retaining hole 320 in a respective one of the legs 32 and a selected one of the retaining grooves 333 in a respective one of the sleeves 33. Each of the retaining grooves 333 is substantially L-shaped so as to prevent undesired removal of the locking members 34 from the retaining grooves 333.

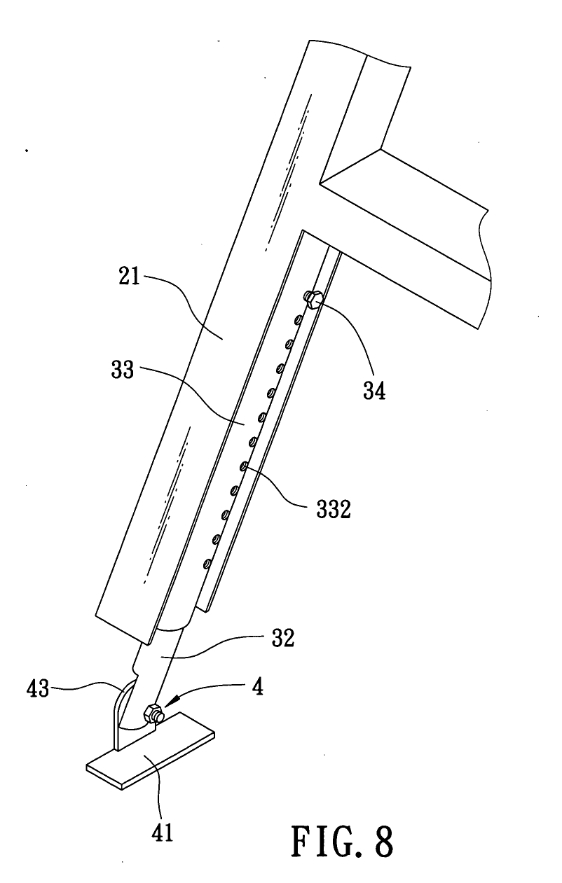

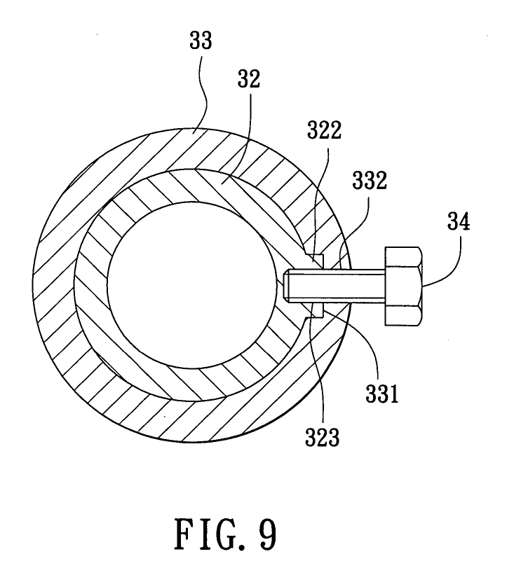

FIGS. 8 and 9 illustrate the fourth preferred embodiment of a ladder according to this invention. The ladder of this embodiment differs from the first embodiment in that the adjusting mechanism of this embodiment includes a plurality of sleeves 33, each of which is secured to a respective one of the side rails 21, each of which extends along the length of the respective one of the side rails 21, and each of which is formed with an elongated groove 331 that extends along the length of the sleeve 33, and a plurality of spaced apart retaining holes 332 that are aligned along the length of the sleeve 33 and that are in spatial communication with the elongated groove 331. Each of the legs 32 extends into a respective one of the sleeves 33, and is formed with a threaded hole 323 and an elongated rail 322 that is slidably received in the elongated groove 331 in the respective one of the sleeves 33 so as to permit alignment of the threaded hole 323 with a selected one of the retaining holes 332 in the respective one of the sleeves 33. A plurality of locking members 34 (only one locking member 34 is shown in FIGS. 8 and 9), each of which is in the form of a threaded bolt, are used for positioning the legs 32 at a desired position relative to the side rails 21. Each of the locking members 34 extends through a respective one of the retaining holes 332 in a respective one of the sleeves 33, and engages threadedly the threaded hole 323 in a respective one of the legs 32.

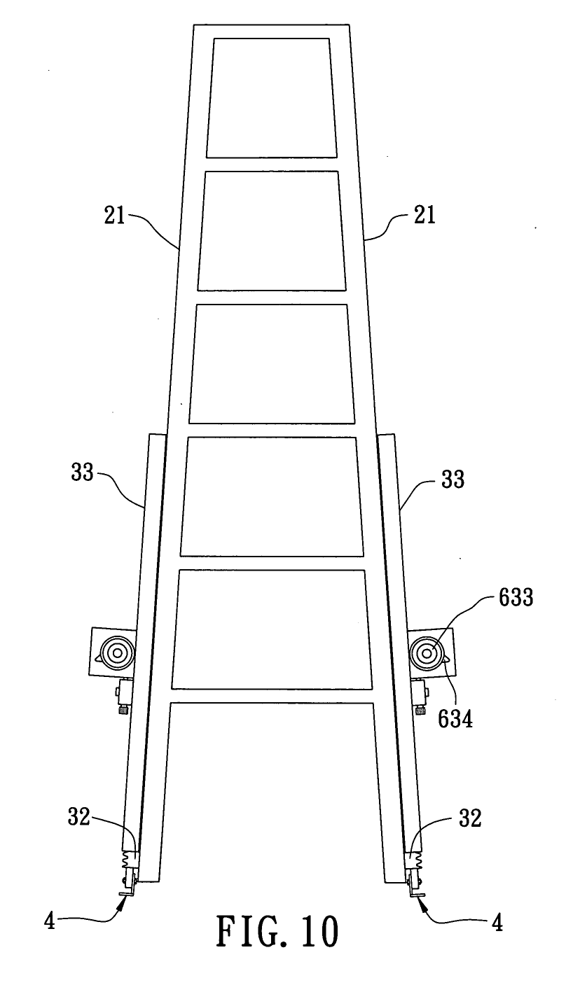

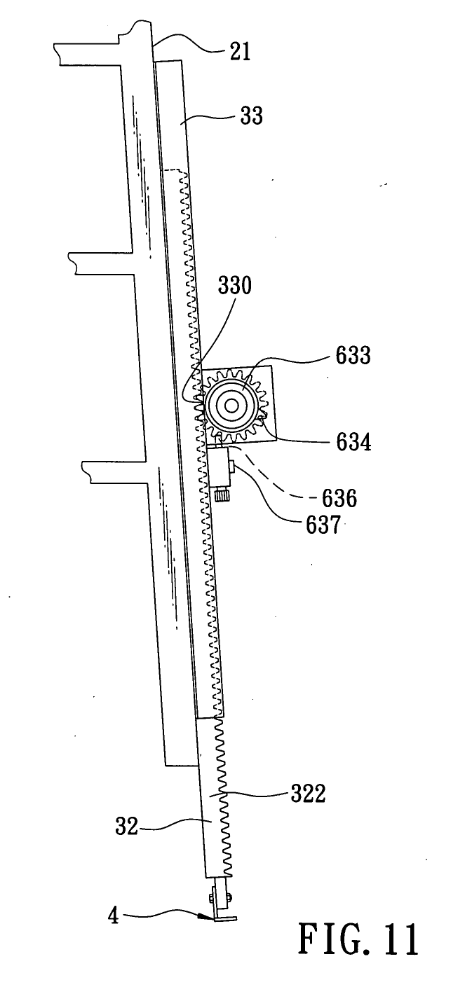

FIGS. 10 and 11 illustrate the fifth preferred embodiment of a ladder according to this invention. The ladder of this embodiment differs from the first embodiment in that the adjusting mechanism of this embodiment includes a plurality of sleeves 33, each of which is secured to a respective one of the side rails 21, each of which extends along the length of the respective one of the side rails 21, and each of which is formed with an opening 330. Each of the legs 32 is provided with a rack 322 that extends into a respective one of the sleeves 33. The ladder further includes a plurality of pinions 633, each of which is mounted rotatably on a respective one of the sleeves 33 adjacent to the opening 330, each of which extends through the opening 330 in the respective one of the sleeves 33 to mesh with the rack 322 of a respective one of the legs 32, and each of which is operable to drive movement of the respective one of the legs 32 relative to the respective one of the sleeves 33. An operating lever 634 is coupled to each pinion 633, and is operable to control rotational directions of the respective pinion 633. A plurality of locking members 636 (only one locking member 636 is shown in FIG. 11), each of which is in the form of a pin, are used for preventing undesired rotation of the pinions 633. Each of the locking members 636 is mounted movably on a respective one of the sleeves 33 adjacent to a respective one of the pinions 633, and is movable between a locking position (see FIG. 11), in which the locking member 636 engages the adjacent one of the pinions 633, and an unlocking position (not shown), in which the locking member 636 disengages from the adjacent one of the pinions 633. A control button 637 is provided for each locking member 636, and is pressable so as to control movement of each of the locking members 636.

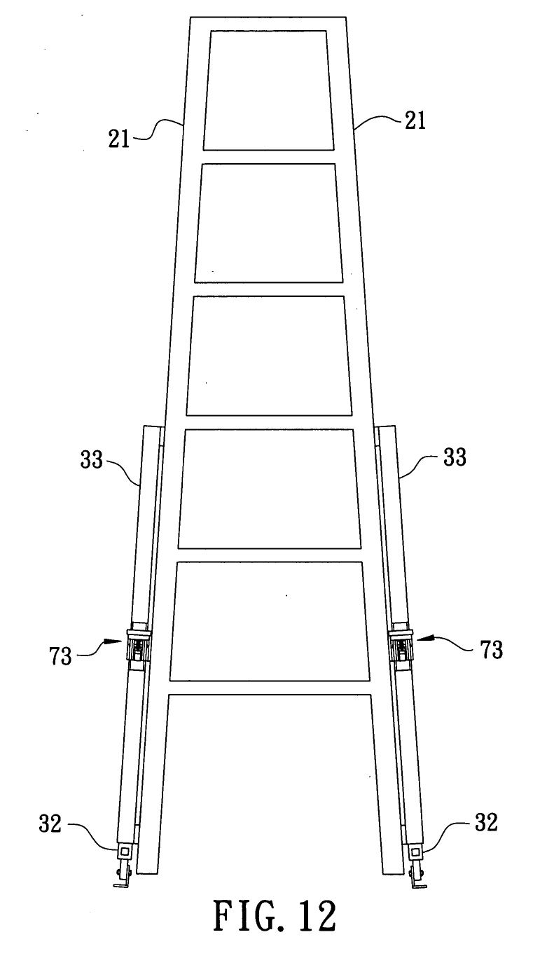

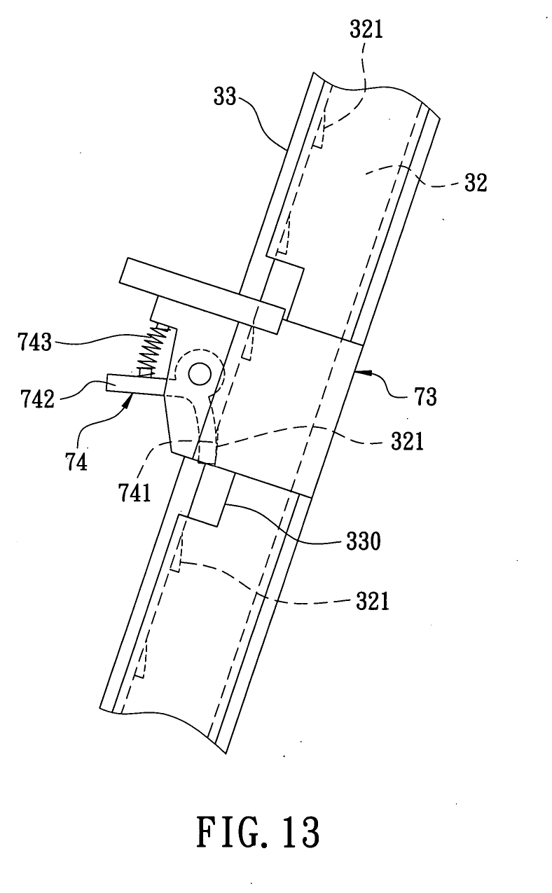

FIGS. 12 and 13 illustrate the sixth preferred embodiment of a ladder according to this invention. The ladder of this embodiment differs from the first embodiment in that the adjusting mechanism of this embodiment includes a plurality of sleeves 33, each of which is secured to a respective one of the side rails 21, each of which extends along the length of the respective one of the side rails 21, and each of which is formed with an opening 330 (see FIG. 13). Each of the legs 32 extends into a respective one of the sleeves 33, and is formed with a plurality of retaining grooves 321 that are aligned along the length of the leg 32. The ladder further includes a plurality of locking members 74, each of which is mounted on a mounting seat that is secured to a respective one of the sleeves 33, each of which is disposed adjacent to the opening 330 in the respective one of the sleeves 33, each of which is pivoted to the respective one of the sleeves 33 so as to be rotatable between locking and unlocking positions, and each of which has an engaging arm 741 that extends through the opening 330 so as to engage a selected one of the retaining grooves 321 in a respective one of the legs 32 when the locking member 741 is disposed at the locking position (see FIG. 13), and an operating arm 742 that extends from the engaging arm 741 and that is operable to rotate the locking member 74 from the locking position to the unlocking position (not shown). An urging member 743 abuts against the mounting seat 73 and the operating arm 742 for restoring the locking member 74 from the unlocking position to the locking position.

By being adjustable in angular position relative to the side rails 21, the shoes 4 can enhance the stability of the ladder of this invention when the ladder stands on an uneven ground surface, thereby eliminating the aforesaid drawback associated with the prior art. Moreover, with the inclusion of the sleeves 33 in the ladder of this invention, formation of grooves or holes in the side rails for engagement with the locking members 34 (636, 74) can be avoided, and the mechanical strength of the ladder can be enhanced.

With the invention thus explained, it is apparent that various modifications and variations can be made without departing from the spirit of the present invention. It is therefore intended that the invention be limited only as recited in the appended claims.

I claim:

1. A ladder comprising:
a ladder frame with a plurality of side rails and a plurality of ladder steps connected to said side rails;
a plurality of legs mounted on said side rails, respectively, and adjustable for adjusting the overall length of each of said side rails and the respective one of said legs, each of said legs having a lower end;
a plurality of shoes, each of which is pivoted to said lower end of a respective one of said legs, each of which has a bottom plate spaced apart from and disposed below said lower end of the respective one of said legs, and each of which is pivotable relative to the respective one of said legs; and
a plurality of fasteners for retaining each of said shoes at a desired angular position relative to the respective one of said legs.

2. The ladder of claim 1, further comprising a plurality of threaded members that are secured to each of said side rails and that are aligned along the length of the respective one of said side rails, each of said legs having a threaded segment that is engageable with said threaded members.

3. The ladder of claim 1, wherein each of said shoes further has a pivot plate that extends from said bottom plate in a transverse direction relative to said bottom plate, each of said fasteners including a screw bolt that extends through said lower end of the respective one of said legs and said pivot plate of the respective one of said shoes, and a nut that engages threadedly said screw bolt.

4. The ladder of claim 1, further comprising a plurality of sleeves, each of which is secured to a respective one of said side rails, each of which extends along the length of the respective one of said side rails, and each of which is formed with a plurality of spaced apart retaining grooves that are aligned along the length of said sleeve, each of said legs extending into a respective one of said sleeves, being formed with a retaining hole, and being movable relative to the respective one of said sleeves so as to permit alignment of said retaining hole with a selected one of said retaining grooves, said ladder further comprising a plurality of locking members, each of which extends through said retaining hole in a respective one of said legs and a selected one of said retaining grooves in a respective one of said sleeves.

5. The ladder of claim 1, further comprising a plurality of sleeves, each of which is secured to a respective one of said side rails, each of which extends along the length of the respective one of said side rails, and each of which is formed with an elongated groove that extends along the length of said sleeve, and a plurality of spaced apart retaining holes that are aligned along the length of said sleeve and that are in spatial communication with said elongated groove, each of said legs extending into a respective one of said sleeves, and being formed with a threaded hole and an elongated rail that is slidably received in said elongated groove in the respective one of said sleeves so as to permit registration of said threaded hole with a selected one of said retaining holes in the respective one of said sleeves, said ladder further comprising a plurality of locking members, each of which extends through a respective one of said retaining holes in a respective one of said sleeves and each of which engages threadedly said threaded hole in a respective one of said legs.

6. The ladder of claim 1, further comprising a plurality of sleeves, each of which is secured to a respective one of said side rails, each of which extends along the length of the respective one of said side rails, and each of which is formed with an opening, each of said legs being provided with a rack that extends into a respective one of said sleeves, said ladder further comprising a plurality of pinions, each of which is mounted rotatably on a respective one of said sleeves adjacent to said opening, each of which extends through said opening in the respective one of said sleeves to mesh with said rack of a respective one of said legs, and each of which is operable to drive movement of the respective one of said legs relative to the respective one of said sleeves.

7. The ladder of claim 6, further comprising a plurality of locking members, each of which is mounted movably on a respective one of said sleeves adjacent to a respective one of said pinions, and each of which is movable between a locking position, in which said locking member engages the adjacent one of said pinions, and an unlocking position, in which said locking member disengages from the adjacent one of said pinions.

8. The ladder of claim 1, further comprising a plurality of sleeves, each of which is secured to a respective one of said side rails, each of which extends along the length of the respective one of said side rails, and each of which is formed with an opening, each of said legs extending into a respective one of said sleeves, and being formed with a plurality of retaining grooves that are aligned along the length of said leg, said ladder further comprising a plurality of locking members, each of which is disposed adjacent to said opening in a respective one of said sleeves, each of which is pivoted to the respective one of said sleeves so as to be rotatable between locking and unlocking positions, and each of which has an engaging arm that extends through said opening so as to engage a selected one of said retaining grooves in a respective one of said legs when said locking member is disposed at said locking position, and an operating arm that extends from said engaging arm and that is operable to rotate said locking member from said locking position to said unlocking position.

9. A ladder comprising:
a ladder frame with a plurality of side rails and a plurality of ladder steps connected to said side rails;
a plurality of sleeves, each of which is secured to a respective one of said side rails, and each of which extends along the length of the respective one of said side rails;
a plurality of legs, each of which extends respectively into said sleeves, and each of which is telescopically adjustable for adjusting the overall length of each of said side rails and the respective one of said legs; and
a plurality of locking members for securing said legs to said sleeves.

10. The ladder of claim 9, wherein each of said sleeves is formed with a plurality of spaced apart retaining grooves that are aligned along the length of said sleeve, each of said legs being formed with a retaining hole, each of said locking members extending through said retaining hole in a respective one of said legs and a selected one of said retaining grooves in a respective one of said sleeves.

11. The ladder of claim 9, wherein each of said sleeves is formed with an elongated groove that extends along the length of said sleeve, and a plurality of spaced apart retaining holes that are aligned along the length of said sleeve and that are in spatial communication with said elongated groove, each of said legs being formed with a threaded hole and an elongated rail that is slidably received in said elongated groove in the respective one of said sleeves so as to permit registration of said threaded hole with a selected one of said retaining holes in the respective one of said sleeves, each of said locking members extending through a respective one of said retaining holes in a respective one of said sleeves, and engaging threadedly said threaded hole in a respective one of said legs.

12. The ladder of claim 9, wherein each of said sleeves is formed with an opening, each of said legs being provided with a rack that extends into a respective one of said sleeves, said ladder further comprising a plurality of pinions, each of which is mounted rotatably on a respective one of said sleeves adjacent to said opening, each of which extends through said opening in the respective one of said sleeves to mesh with said rack of a respective one of said legs, and each of which is operable to drive movement of the respective one of said legs relative to the respective one of said sleeves, each of said locking members being mounted movably on a respective one of said sleeves adjacent to a respective one of said pinions, and being movable between a locking position, in which said locking member engages the adjacent one of said pinions, and an unlocking position, in which said locking member disengages from the adjacent one of said pinions.

13. The ladder of claim 9, wherein each of said sleeves is formed with an opening, each of said legs being formed with a plurality of retaining grooves that are aligned along the length of said leg, each of said locking members being disposed adjacent to said opening in a respective one of said sleeves, being pivoted to the respective one of said sleeves so as to be rotatable between locking and unlocking positions, and having an engaging arm that extends through said opening so as to engage a selected one of said retaining grooves in a respective one of said legs when said locking member is disposed at said locking position, and an operating arm that extends from said engaging arm and that is operable to rotate said locking member from said locking position to said unlocking position.
